(19) United States
(12) Patent Application Publication
(10) Pub. No.: US 2019/0203919 A1
(43) Pub. Date: Jul. 4, 2019

(54) Two-step switch for portable lighting apparatus and a portable lighting apparatus

(71) Applicant: Jiang FAN, HuBei (CN)

(72) Inventor: Jiang FAN, HuBei (CN)

(21) Appl. No.: 15/890,368

(22) Filed: Feb. 7, 2018

(30) Foreign Application Priority Data
Jan. 3, 2018 (CN) 201820007589.1

(51) Int. Cl. F21V 23/04; H01H 13/807

(52) U.S. Cl. CPC F21V 23/0421; F21V 21/0885; H01H 13/807

(57) ABSTRACT

The present invention relates to a portable lighting apparatus and more particularly pertains to a two-step switch for portable lighting apparatus and a portable lighting apparatus. The two-step switch comprises a casing, a key, a PCB board and a voltage ring sleeved outside of the key. A first spring is disposed between the voltage ring and the PCB board. A second spring is disposed at an end of the voltage ring which is distal from the first spring. The two-step switch is disposed at the end of the portable lighting apparatus which is distal from the light emitting means thereof. The present invention performs switching control of the portable lighting apparatus by the first spring and the second spring, increases the keystroke between the first step switch and the second step switch, and prevents mis-pressing.

### BACKGROUND OF THE INVENTION

The present invention relates to portable lighting apparatus and more particularly pertains to a two-step switch for portable lighting apparatus and a portable lighting apparatus.

Portable lighting apparatus is commonly used in daily life to facilitate people to recognize roads when there is no street lamp. Two-step switches in existing portable lighting apparatus are mainly in form of two-step tact switches and two-step snap domes. Such switches have a shorter keystroke and easily switch on the second step switch when switching on the first step switch, thereby causing use inconvenience. Besides, snap dome switches change state easily, resulting in the switches being out of order.

In view of the above, a two-step switch and a portable lighting apparatus which have reasonable keystroke and high durability are highly expected in the current technological field.

### BRIEF SUMMARY OF THE INVENTION

In view of the aforesaid disadvantages now present in the prior art, the present invention provides a two-step switch for portable lighting apparatus and a portable lighting apparatus.

To attain this, the present invention adopts the following technical solution:

A two-step switch for portable lighting apparatus comprises a casing, a key and a PCB board. It further comprises a voltage ring sleeved outside of the key, a first spring disposed between the voltage ring and the PCB board, and a second spring disposed at an end of the voltage ring which is distal from the first spring.

Furthermore, the voltage ring is in cone shape; a limiting base is provided at a bottom end periphery of the voltage ring for limiting the second spring.

Furthermore, an electrically conducting cloth is disposed on an end of the voltage ring which is proximal to the second spring.

Furthermore, a key cap is disposed between the second spring and the casing; the key cap extends out of an end of the casing which is distal from the second spring; the casing is provided with a through hole which corresponds to the key cap.

Furthermore, the key cap is provided with anti-slip protrusions on a side which is distal from the second spring.

Furthermore, the PCB board has a first step switch at a periphery thereof and a second step switch at a middle position thereof.

Furthermore, the first step switch is a connecting finger switch.

Furthermore, the second step switch is a surface mount switch.

Furthermore, the first spring has a smaller wire diameter than that of the second spring.

A portable lighting apparatus comprises any of the above two-step switches; the two-step switch is disposed at the end of the portable lighting apparatus which is distal from a light emitting means thereof.

The present invention has the following advantages:

The present invention controls the switch by the first spring and the second spring; the first step switch is controlled by the first spring disposed between the voltage ring and the PCB board; the second step switch is controlled by the second spring disposed between the voltage ring and the key cap. The first spring and the second spring control the opening and closing of the switch separately, so that the switch has a more reasonable keystroke. The springs are difficult to deform, have high reset capability and are durable.

### BRIEF DESCRIPTION OF THE DRAWINGS

FIG. 1 shows a disassembled view of the two-step switch.

FIG. 2 shows the structure of the voltage ring.

FIG. 3 shows the structure of the PCB board.

In the drawings, 1 denotes the casing, 101 denotes the through hole, 2 denotes the key cap, 201 denotes the anti-slip protrusion, 3 denotes the second spring, 4 denotes the voltage ring, 401 denotes the limiting base, 402 denotes the electrically conductive cloth, 5 denotes the key, 6 denotes the first spring, 7 denotes the PCB board, 701 denotes the first step switch, 702 denotes the second step switch, 703 denotes the frame, 8 denotes the portable lighting apparatus.

### DETAILED DESCRIPTION OF THE INVENTION

An embodiment of the present invention is described in detail herein. An example of the embodiment is illustrated in the accompanying drawings, in which the same or similar reference numbers are used to designate identical or similar parts or parts with identical or similar functions. The embodiment described herein with the accompanying drawings is illustrative of the present invention and should not limit the scope of the present invention.

In the description herein, it should be understood that the orientation or spatial relationship designated by the terms “length”, “width”, “above”, “below”, “front”, “rear”, “left”, “right”, “vertical”, “horizontal”, “top”, “bottom”, “inside”, “outside” and the like is the orientation or spatial relationship based on the accompanying drawings, which is solely for the purpose of describing the present invention in a simplified manner and does not indicate or imply that the designated apparatus or parts must have a particular orientation or must form or operate in a particular orientation, and thus should not limit the scope of the present invention.

Besides, the terms “first” and “second” are only used for illustrative purposes and should not be interpreted as indicating or implying relative importance or the number of the designated element. Therefore, the element designated as “the first element” and “the second element” may indicate or imply that one or more of such element are present. In the description herein, the term “a plurality of” means two or more than two, unless otherwise specified.

In the embodiment of the present invention, unless otherwise specified, the terms “install”, “connected to”, “coupled to”, “fixed to” and the like should be interpreted in their broadest sense. For example, they may be interpreted as connected in a fixed manner, or connected in a removable manner, or integrally connected; they may also be interpreted as connected mechanically, or connected electrically; they may also be interpreted as connected directly, or connected indirectly via an intermediary element; they may also be interpreted as the internal connection between two elements, or the interaction between two elements. A person skilled in the art should interpret the actual meaning of the above terms in the present invention based on actual situation.

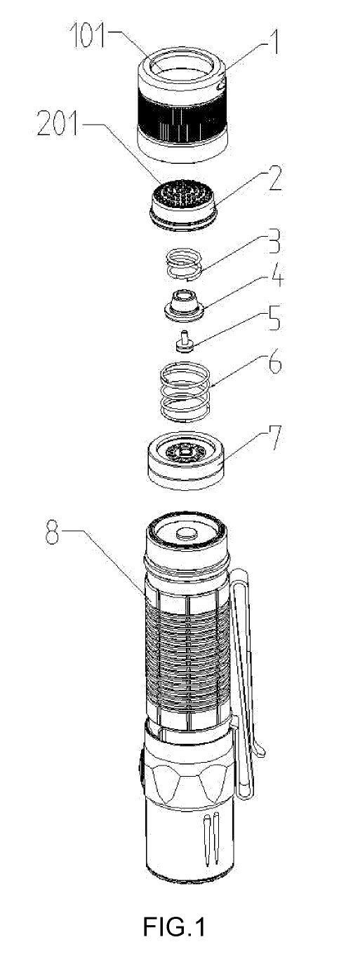

As illustrated in FIG. 1, the present embodiment provides a two-step switch for portable lighting apparatus which comprises a casing 1, a key 5 and a PCB board 7. It further comprises a voltage ring 4 sleeved outside of the key 5. A first spring 6 is disposed between the voltage ring 4 and the PCB board 7. A second spring 3 is disposed at an end of the voltage ring 4 which is distal from the first spring 6. The casing 1 is connected to an end of a portable lighting apparatus 8 which is distal from a light emitting means thereof. The second spring 3, the voltage ring 4, the key 5, the first spring 6 and the PCB board 7 are sequentially disposed towards the portable lighting apparatus. A key cap 2 is disposed between the second spring 3 and the casing 1. The key cap 2 extends out of an end of the casing 1 which is distal from the second spring 3. The casing 1 is provided with a through hole 101 which corresponds to the key cap 2 for users to press. The key cap 2 is sleeved outside of the second spring 3. The key cap 2 is provided with anti-slip protrusions 201 outside to prevent slipping when being pressed by users. The first spring 6 has a smaller wire diameter than that of the second spring 3; therefore, upon pressing by a user, the first spring 6 with the smaller wire diameter contracts first, and upon further pressing the second spring 3 then contracts.

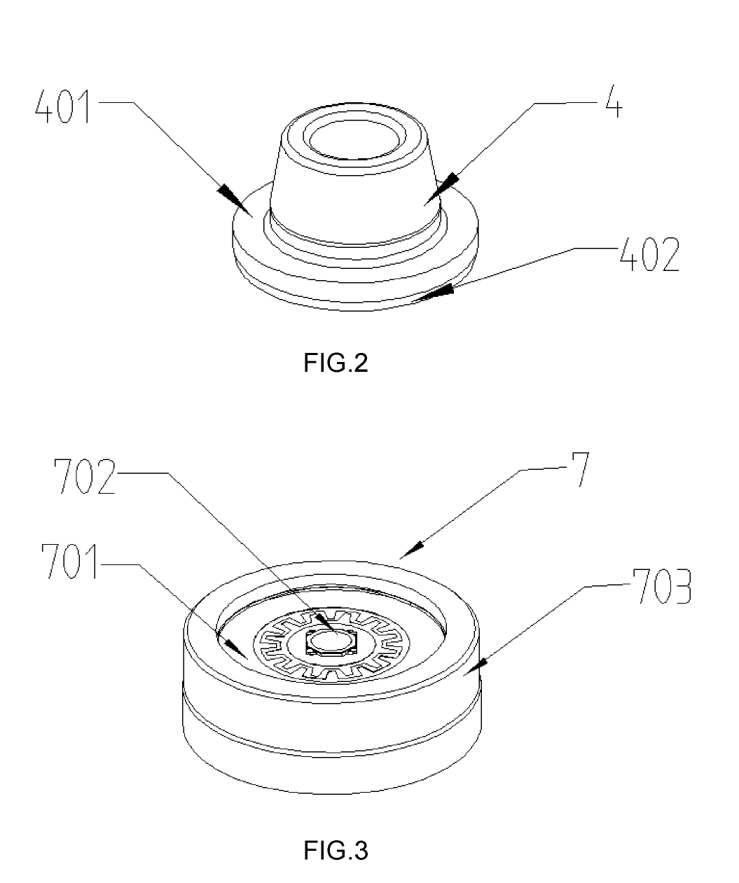

As illustrated in FIG. 2, in the present embodiment, the voltage ring 4 is in cone shape. A limiting base 401 is provided at its bottom end periphery for limiting the second spring 3. The second spring 3 is disposed on the limiting base 401. An electrically conducting cloth 402 is disposed on an end of the voltage ring 4 which is proximal to the second spring 3 for closing the circuit.

As illustrated in FIG. 3, in the present embodiment, the PCB board 7 has a first step switch 701 at a periphery thereof and a second step switch 702 at a middle position thereof. The first step switch 701 is a connecting finger switch. The second step switch 702 is a surface mount switch. The PCB board 7 is disposed inside a frame 703 for fixing the position of the PCB board 7.

When in use, the user first presses the key cap 2 downwards, causing the first spring 6 to contract first. The electrically conducting cloth 402 at a lower portion of the voltage ring 4 first contacts and switches on the first step switch 701 of the PCB board 7, thereby closing the corresponding circuit for a first light emitting means (not shown in the drawings). The first light emitting means (not shown in the drawings) is switched on, resulting in the first lighting level. Upon further pressing of the key cap 2, the second spring 3 contracts and causes the key 5 to contact the second step switch 702 of the PCB board 7, thereby closing the corresponding circuit for a second light emitting means (not shown in the drawings). The second light emitting means is switched on, resulting in the second lighting level.

In the embodiment, a portable lighting apparatus is further provided, which include any of the above two-step switches. The two-step switch is disposed at the end of the portable lighting apparatus which is distal from the light emitting means thereof. The two-step switch controls the first light emitting means and the second light emitting means of the portable lighting apparatus separately, thus attaining different lighting levels.

The above embodiment is a preferred embodiment of the present invention. Conventional variation and substitution made by a person skilled in the art falls within the scope of protection of the present invention.

What is claimed is:

1. A two-step switch for portable lighting apparatus comprising a casing (1), a key (5) and a PCB board (7), characterized in that it further comprises a voltage ring (4) sleeved outside of the key (5), a first spring (6) disposed between the voltage ring (4) and the PCB board (7), and a second spring (3) disposed at an end of the voltage ring (4) which is distal from the first spring (6).

2. The two-step switch for portable lighting apparatus as in claim 1, characterized in that the voltage ring (4) is in cone shape; a limiting base (41) is provided at a bottom end periphery of the voltage ring for limiting the second spring (3).

3. The two-step switch for portable lighting apparatus as in claim 1, characterized in that an electrically conducting cloth (402) is disposed on an end of the voltage ring (4) which is proximal to the second spring (3).

4. The two-step switch for portable lighting apparatus as in claim 1, characterized in that a key cap (2) is disposed between the second spring (3) and the casing (1); the key cap (2) extends out of an end of the casing (1) which is distal from the second spring (3); the casing (1) is provided with a through hole (101) which corresponds to the key cap (2).

5. The two-step switch for portable lighting apparatus as in claim 4, characterized in that the key cap (2) is provided with anti-slip protrusions (201) on a side which is distal from the second spring (3).

6. The two-step switch for portable lighting apparatus as in claim 1, characterized in that the PCB board (7) has a first step switch (701) at a periphery thereof and a second step switch (702) at a middle position thereof.

7. The two-step switch for portable lighting apparatus as in claim 6, characterized in that the first step switch (701) is a connecting finger switch.

8. The two-step switch for portable lighting apparatus as in claim 6, characterized in that the second step switch (702) is a surface mount switch.

9. The two-step switch for portable lighting apparatus as in claim 1, characterized in that the first spring (6) has a smaller wire diameter than that of the second spring (3).

10. A portable lighting apparatus, characterized in that it comprises the two-step switch as in claim 1; the two-step switch is disposed at an end of the portable lighting apparatus which is distal from a light emitting means thereof.
